(19) United States
(12) Patent Application Publication
(10) Pub. No.: US 2012/0158462 A1
(43) Pub. Date: Jun. 21, 2012

(54) TARGET LEVEL SETTING

(76) Inventors: Filippo Balestrieri, Mountain View, CA (US); Kay-Yut Chen, Santa Clara, CA (US); Ferydoon Safai, Los Altos Hills, CA (US); Maria Teresa Gonzalez Diaz, Mountain View, CA (US)

(21) Appl. No.: 12/968,929

(22) Filed: Dec. 15, 2010

(51) Int. Cl. G06Q 10/00

(52) U.S. Cl. 705/7.36; 705/1.1

(57) ABSTRACT

Systems, methods, and machine readable and executable instructions are provided for target level setting. Target level setting may include receiving a plurality of objectives for an organization that includes a central unit and a plurality of regional units, transmitting a respective regional target level for each of the plurality of objectives assigned to each of the plurality of regional units, prompting the central unit for an approval of an increase to a first regional target level for a first of the plurality of regional units and a decrease to a second regional target level for a second of the plurality of regional units, increasing the first regional target level for the first of the plurality of regional units, and decreasing the second regional target level for the second of the plurality of regional units.

### BACKGROUND

Some organizations are designed to provide goods, services, or both to consumers or a tertiary business in exchange for compensation. Some organizations may be formed to earn profit and some organizations may be not-for-profit. Some organizations may be referred to as business organizations.

To help organizations operate efficiently and effectively the organization may be managed. Types of organization management include, but are not limited to, financial management, marketing management, human resource management, strategic management, production management, operation management, service management and information technology management.

Organization management may include determining and fulfilling a business objective. Examples of business objectives include obtaining a certain percentage of market share, profits, and/or an increase in sales.

### BRIEF DESCRIPTION OF THE FIGURES

FIG. 1 illustrates a block diagram of an example of a system for target level setting according to the present disclosure.

FIG. 2 provides a flow chart illustrating an example of a method for target level setting according to the present disclosure.

FIG. 3 illustrates a block diagram illustrating an example of machine readable non-transitory medium storing a set of instructions executable by the machine to cause the machine to perform target level setting according to the present disclosure.

FIG. 4 illustrates a flow chart illustrating an example of a target level setting according to the present disclosure.

FIG. 5 illustrates a block diagram of an example of a machine readable medium in communication with processor resources according to the present disclosure.

### DETAILED DESCRIPTION

Examples of the present disclosure may include computing device implemented methods for target level setting, machine readable non-transitory mediums storing a set of instructions executable by the machine, and systems for target level setting. Target level setting may include receiving a plurality of objectives for an organization that includes a central unit and a plurality of regional units, transmitting a respective regional target level for each of the plurality of objectives assigned to each of the plurality of regional units, increasing a first regional target level for a first of the plurality of regional units, decreasing a second regional target level for a second of the plurality of regional units, and prompting the central unit for an approval of the increased first regional target level and the decreased second regional target level. The computing device implemented methods for target level setting, machine readable non-transitory mediums storing a set of instructions executable by the machine, and systems for target level setting as disclosed herein are useful to organizations that include a central unit and a plurality of regional units.

Target level setting according to the present disclosure is advantageous relative to previous target setting procedures in that adjustments to regional target levels may be initiated by a regional unit. These proposed adjustments may be based, at least in part, on information that is specific to a regional unit. Because the regional units may adjust one or more of their respective regional target levels, the regional units have incentive to share the specific information and thus adjust the regional target levels, while satisfying one or more objectives of an organization.

Additionally, target level setting according to the present disclosure is advantageous relative to previous target setting procedures in that a central unit of an organization is relieved of some monitoring responsibilities of regional units of the organization. For example, because the regional units have incentive to share specific information to adjust one or more of their respective regional target levels the central unit may not have to preform some monitoring of the regional units with respect to those regional target levels.

According to some examples of the present disclosure, the organization may be a business organization. According to some examples of the present disclosure, the organization may be a sole proprietorship, a corporation, a partnership, an S-corporation, or a non-profit organization. As mentioned, the organization includes a central unit and a plurality of regional units. The central unit may manage the plurality of regional units. For example, the central unit may control and/or coordinate the plurality of regional units. The central unit may operate, amongst other things, to generate recurring income for the organization, increase a value of an asset of the organization, and/or secure income and value of the organization.

As mentioned, the organization includes a central unit and a plurality of regional units. The plurality of regional units may perform one or more functions for the organization. For example, the plurality of regional units may provide a good and/or service on behalf of the organization. According to some examples of the present disclosure, the regional units may be geographically separated, e.g. in differing regions. However, according to some examples of the present disclosure the regional units may be located in the same region, e.g. when the regional units share a common location but provide a good or service to differing geographical regions or the regional units provide a differing good or service. The regional units may have various degrees of similarity in the goods and/or services that they provide. For example, according to some examples of the present disclosure, each of the regional units may provide the same goods or services. According to some examples of the present disclosure a number of the regional units may provide a good or service that another number of the regional units does not provide. According to some examples of the present disclosure, a regional unit may be considered to be a department, a division, and/or a peripheral of the organization.

Organizations, which have a central unit that manages the plurality of regional units, have attempted to collect information from the regional units via a one-to-one relationship with each of the plurality of regional units. The one-to-one relationship may include a meeting and/or an interview between the central unit and each of the plurality of regional units. It has been found, in some instances, that when the regional units are rewarded upon the fulfillment of pre-specified target levels, the regional units do not have an incentive to share, e.g. unwilling to share, information with the central unit and/or other regional units. After the one-to-one meetings and/or interviews with each of the plurality of regional units were completed, the central unit conducted a series of one-to-one negotiations with each of the plurality of regional units. During the one-to-one negotiations the central unit set target levels. The target levels for objectives of the organization that were set by the central unit were based, at least in part on the interviews.

Previously, a plurality of regional units of an organization, which has a central unit that manages the plurality of regional units, have operated in relative isolation of one another. In other words, each regional unit is not affected by particular business occurrences in another region. For example, sales in a first region will not affect sales in a second region, thus the first regional unit and the second regional unit are relatively isolated. This relative isolation of the regional units has included an information asymmetry such that each regional unit has acquired region specific information that is not shared with the other regional units and/or the central unit. The information asymmetry may have an undesirable effect on the organization including, but not limited to, setting one or more erroneous target levels. A target level may be erroneous when the target level is unobtainable by the regional unit, e.g. the target level is too high for the regional unit to obtain. Additionally, a target level may also be erroneous when the target level undervalues the regional unit's capacity to obtain the target level, e.g. the target level is too low for the regional unit such that the regional unit has capacity to obtain a relatively higher target level.

In the detailed description of the present disclosure, reference is made to the accompanying drawings that form a part hereof, and in which is shown by way of illustration how examples of the disclosure may be practiced. These examples are described in sufficient detail to provide enablement and it is to be understood that other examples may be utilized and that process, electrical, and/or structural changes may be made without departing from the scope of the present disclosure.

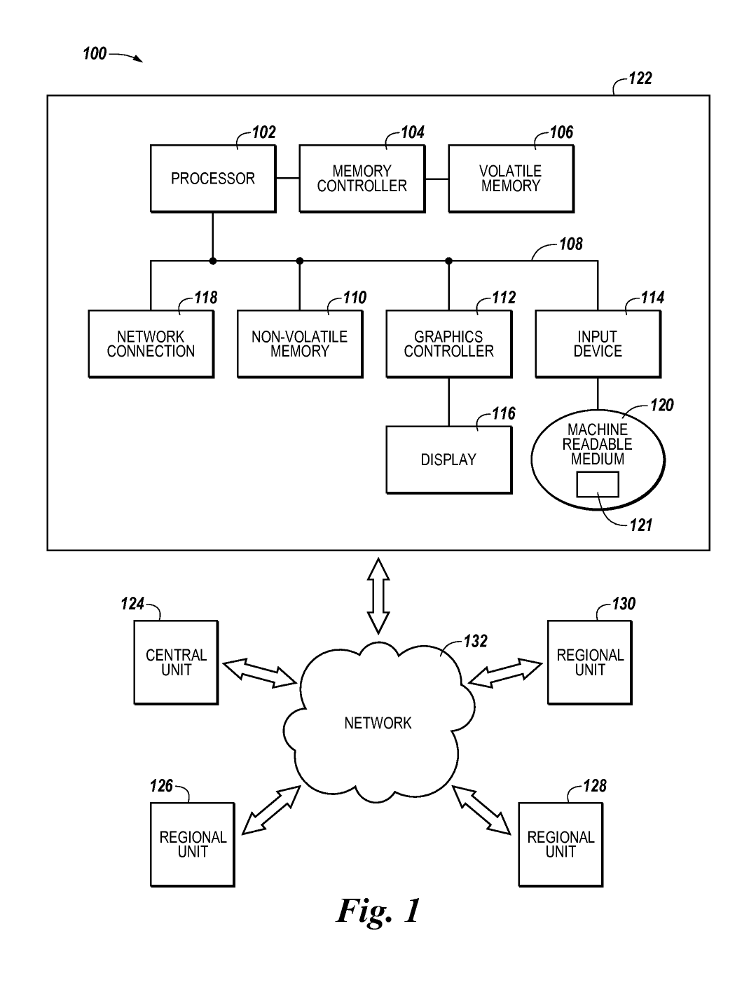

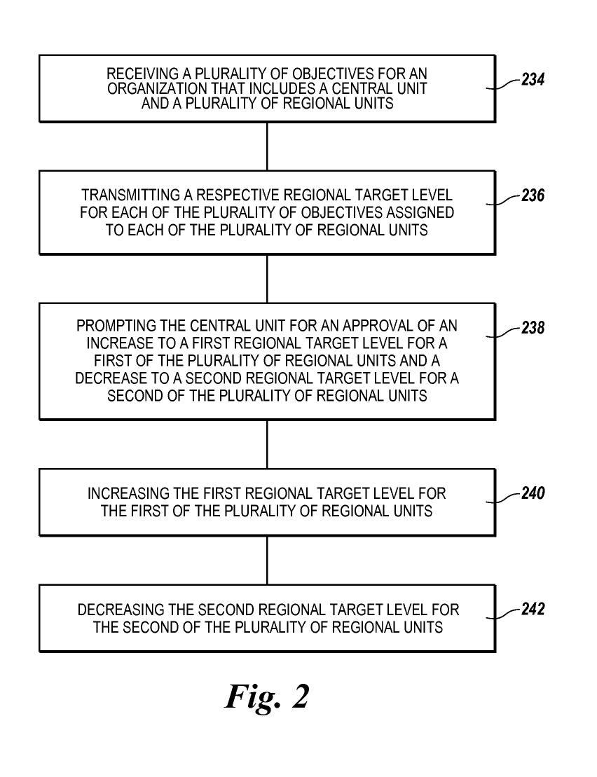

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 illustrates a block diagram of an example of a system 100 for target level setting according to the present disclosure. The system 100 can include processor resources 102 and memory resources, e.g., volatile memory 106 and/or non-volatile memory 110, for executing instructions stored in a tangible non-transitory medium, e.g., volatile memory 106, non-volatile memory 110, and/or machine readable medium 120, and/or an application specific integrated circuit (ASIC) including logic configured to perform various examples of the present disclosure. The system 100 can include computer readable instructions 121 to perform a method as described herein. A machine 122, e.g., a computing device, can include and/or receive a tangible non-transitory machine readable medium 120 storing a set of machine readable instructions, e.g., software, via an input device 114. According to some examples of the present disclosure, the machine 122 may be a server computer, a personal computer, e.g. a desktop computer, a workstation or a portable computer such as, for example, a laptop or notebook computer, or a handheld computing device. Components of system 100 may be included in the machine 122 or may be distributed amongst a number of machines. As used herein, processor resources 102 can include one or a plurality of processors such as in a parallel processing system. Memory resources can include memory addressable by the processor resources 102 for execution of machine readable instructions. The machine readable medium 120 can include volatile and/or non-volatile memory such as random access memory (RAM), magnetic memory such as a hard disk, floppy disk, and/or tape memory, a solid state drive (SSD), flash memory, phase change memory, etc. In some examples of the present disclosure, the non-volatile memory 110 can be a database including a plurality of physical non-volatile memory devices. In various examples of the present disclosure, the database can be local to a particular system or remote.

The processor resources 102 can control the overall operation of a portion the system 100. The processor resources 102 can be connected to a memory controller 104, which can read and/or write data from and/or to volatile memory 106 (e.g., RAM). The memory controller 104 can include an ASIC and/or a processor with its own memory resources (e.g., volatile and/or non-volatile memory). The volatile memory 106 can include one or a plurality of memory modules (e.g., chips). A basic input-output system (BIOS) for the system 100 may be stored in non-volatile memory 110 or other non-volatile memory not specifically illustrated, but associated with the processor resources 102. The BIOS can control a start-up or boot process and control basic operation of the system 100.

The processor resources 102 can be connected to a bus 108 to provide for communication between the processor resources 102 and one or more components of the system 100. For example, according to some examples of the present disclosure, the bus 108 may operate under a standard protocol such as a variation of the Peripheral Component Interconnect (PCI) bus standard, or the like. The bus 108 can connect the processor resources 102 to the non-volatile memory 110, graphics controller 112, input device 114, and/or the network connection 118, among other components of the system 100. The non-volatile memory 110 (e.g., hard disk, SSD, etc.) can provide persistent data storage for the system 100. The graphics controller 112 can connect to a display device 116, which can provide an image to a user based on activities performed by the system 100. The central unit 124 may communicate with the regional units 126 via network connection 118 and/or network 132. Network 132 may be an intranet or the Internet. A unit of the organization, e.g., central unit 124 or one of the plurality of regional units 126, 128, 130 may include machine 122. However, machine 122 may be located apart from central unit 124 or the plurality of regional units 126, 128, 130.

FIG. 2 provides a flow chart illustrating an example of a method for target level setting according to the present disclosure. According to some examples of the present disclosure, the method can be performed via a machine readable non-transitory medium storing a set of instructions executable by the machine to cause the machine to perform the method as described herein. The method can include receiving 234 a plurality of objectives for an organization that includes a central unit and a plurality of regional units. The plurality of objectives may include business objectives and/or business constraints for the organization. For example, the plurality of objectives may include, but are not limited to, a percentage of market share to be obtained, profits to be obtained, and/or an increase in sales to be obtained. According to some examples of the present disclosure, the plurality of objectives may be provided by the central unit.

The method can include transmitting 236 a respective regional target level for each of the plurality of objectives assigned to each of the plurality of regional units. According to some examples of the present disclosure, the central unit may determine the respective regional target levels for each of the plurality of objectives. For example, the central unit may determine that an objective of the organization is to obtain a particular increase in sales. The central unit may apportion the particular increase in sales, and/or any other objective of the organization, among the plurality of regional units such that the respective regional target levels sum to the total increase in sales that is sought to be obtained by the organization. According to some examples of the present disclosure, the portion of the increase in sales corresponding to a specific unit of the plurality of regional units is the respective regional target level. A respective regional target level can be determined for each of the plurality of regional units for each of the plurality of objectives for the organization.

The method can include increasing 240 a first regional target level for a first of the plurality of regional units. The method can include decreasing 242 a second regional target level for a second of the plurality of regional units. As discussed, the central unit may determine respective regional target levels for each of the plurality of regional units for each of the plurality of objectives of the organization. As such, increasing the first regional target level and decreasing the second regional target level may be initiated by the central unit. The central unit may initiate the adjustments based, at least in part, upon one or more of the plurality of objectives for the organization. Additionally, the central unit may determine that a resource change shall result in an adjustment of a regional target level. For example, the central unit may determine that a resource, e.g. a business parameter, has changed. With this determination, the central unit may initiate an increase to a first regional target level for a first of the plurality of regional units and a decrease to a second regional target level for a second of the plurality of regional units.

Furthermore, according to some examples of the present disclosure, the central unit may determine a possible trade-off available to one or more of the plurality of regional units regarding the respective regional target levels assigned to each of the plurality of regional units. For example, the central unit may determine that a particular regional target level can be increased while another particular regional target level can be decreased, such that the plurality of objectives of the organization remain obtainable. One or more of the plurality of regional units may propose an adjusted regional target level for one or more respective target levels, for example after the central unit has determined the possible trade-off and the possible trade-off has been transmitted to the plurality of regional units. The proposals, e.g., adjusted regional target levels, may be transmitted so that the central unit and/or another of the plurality of regional units may view the proposals. One or more of the plurality of regional units may propose another adjusted regional target level, for example after one or more of the plurality of regional units has received the proposal for the adjusted regional target level. As such, increasing a regional target level may include receiving a proposed increase in the first regional target level that is initiated by the first of the plurality of regional units. According to some examples of the present disclosure, the central unit may offer the increase in the respective regional target in return for a decrease in another respective regional target, thus there is a trade-off to one or more of the plurality of regional units regarding the respective regional target levels assigned to each of the plurality of regional units.

The method can include prompting 238 the central unit for an approval of an increase to a first regional target level and/or a decrease to a second regional target level. As discussed, the central unit may determine the respective regional target levels for each of the plurality of objectives and one or more of the respective regional target units may be increased and/or decreased. While one or more of the respective regional target units may be adjusted, it is desirable that the plurality of objectives of the organization is obtained. According to some examples of the present disclosure, the method may include verifying that the plurality of objectives of the organization is satisfied. For example, a proposed adjustment to a first regional target level and a proposed adjustment to a second regional target level may be verified to ensure that implementing the proposed adjustments would satisfy the plurality of objectives of the organization. However, there may be a proposed adjustment to one or more regional target levels that renders the plurality of objectives of the organization unobtainable. As such, according to some examples of the present disclosure, the central unit may be prompted for approval of the proposed adjustments to the respective regional target levels.

According to some examples of the present disclosure, the central unit may offer one or more counter-proposals based upon the proposed adjustments to the respective regional target levels. For example, the central unit may determine that a proposed adjustment to a regional target level has a value that is too low or that a proposed adjustment has a value that is too high. As such, the central unit may counter-propose a higher value for the proposed adjustment or counter-propose a lower value for the proposed adjustment or counter-propose a change in another regional unit's target to balance the proposed adjustment in light of the overall organization objectives.

According to some examples of the present disclosure, a first regional target level, e.g. a regional target level that is increased, can correspond to a first objective of the plurality of objectives and a second regional target level, e.g. a regional target level that is decreased, can correspond to a second objective of the plurality of objectives. For example, the plurality of objectives of the organization can include a percentage of market share to be obtained, profits to be obtained, and an increase in sales to be obtained. According to some examples of the present disclosure, a regional target level of market share to be obtained may be increased while a regional target level of profits to be obtained may be decreased.

According to some examples of the present disclosure, the method can include implementing a level of transparency that controls information viewable by each of the plurality of regional units. According to some examples of the present disclosure, a level of transparency may be implemented such that a respective regional unit may only view information that is associated with that regional unit. For example, a level of transparency may be implemented such that a respective regional unit may only view respective regional target levels that are assigned to that particular regional unit.

According to some examples of the present disclosure, a level of transparency may be implemented such that a respective regional unit may view information that is associated with another regional unit. For example, a level of transparency may be implemented such that a respective regional unit may view respective regional target levels that are assigned to that particular regional unit as well respective regional target levels that are assigned to another regional unit. According to some examples of the present disclosure, the central unit may determine a respective level of transparency for each of the plurality of regional units. As such, a proposed increase to the first regional target level may be initiated by a first of the plurality of regional units and be based upon the first of the plurality of regional units viewing a second regional target level of a second of the plurality of regional units. Additionally, a proposed decrease may be initiated by a second of the plurality of regional units and be based upon the second of the plurality of regional units viewing the first regional target level of the first of the plurality of regional units. As mentioned, one or more of the plurality of regional units may propose an adjusted regional target level for one or more respective target levels. The proposals, e.g., adjusted regional target levels, may be transmitted so that the central unit and/or another of the plurality of regional units may view the proposals.

According to some examples of the present disclosure, a regional target level and/or a proposed adjustment for a regional target level may correspond to a current business period of the organization, such as a business period for which the organization has provided the plurality of objectives, e.g. a particular quarter or a particular fiscal year. According to some examples of the present disclosure, a regional target level and/or a proposed adjustment for a regional target level may correspond to a future business period of the organization, such as a business period for which the organization will provide a plurality of objectives, e.g. a quarter or a fiscal year that is subsequent to the particular quarter or the particular fiscal year as discussed for the current business period.

According to some examples of the present disclosure, a regional unit may offer one or more counter-proposals based upon a proposed adjustment to a respective regional target levels. For example, the regional unit may view information that is associated with another regional unit and offer a counter-proposal to the proposed adjustment. Thereafter, the regional unit may receive a subsequent, e.g. revised, a proposed adjustment to a respective regional target levels from another regional unit.

According to some examples of the present disclosure, the central unit may receive and/or analyze proposed adjustments to respective regional target levels and/or counter-proposals within a predetermined time interval. According to some examples of the present disclosure, the central unit may receive and/or analyze proposed adjustments to respective regional target levels and/or counter-proposals simultaneously. This provides an advantage relative to previous target setting procedures as practiced by organizations that have operated in a sequential one-to-one relationship with each of the plurality of regional units. For example, an organization may operate more efficiently when receiving and/or analyzing proposed adjustments to respective regional target levels and/or counter-proposals within a predetermined time interval or simultaneously, as compared to organizations that have operated in a sequential one-to-one relationship with each of the plurality of regional units.

The target level setting, as described herein, may be viewed as a collaborative platform wherein the central unit and the plurality of regional units collaborate to achieve the objectives of the organization. The regional units are motivated to share information with the central unit and/or other regional units to take advantage of opportunities to favorably adjust a target level. For example, a regional unit may have specific information that that regional unit has capacity to exceed a market share target level, but will be unable to achieve a particular profits target level. That regional level is motivated to share the specific information in order to seek a trade-off from another regional unit, e.g. a regional unit having capacity to exceed the particular profits level either for a current business period or a future business period.

The target level setting, as described herein, is dynamic and may help to provide an efficient and effective tool for the organization to manage continuously changing business conditions. This target level setting advantageously allows for target level setting to be initiated by one or more of the regional units at anytime. Target level setting, as discussed herein, may provide an intertemporal property, for example that may help a regional unit may implement an insurance strategy, such as trading present opportunities against future hedging.

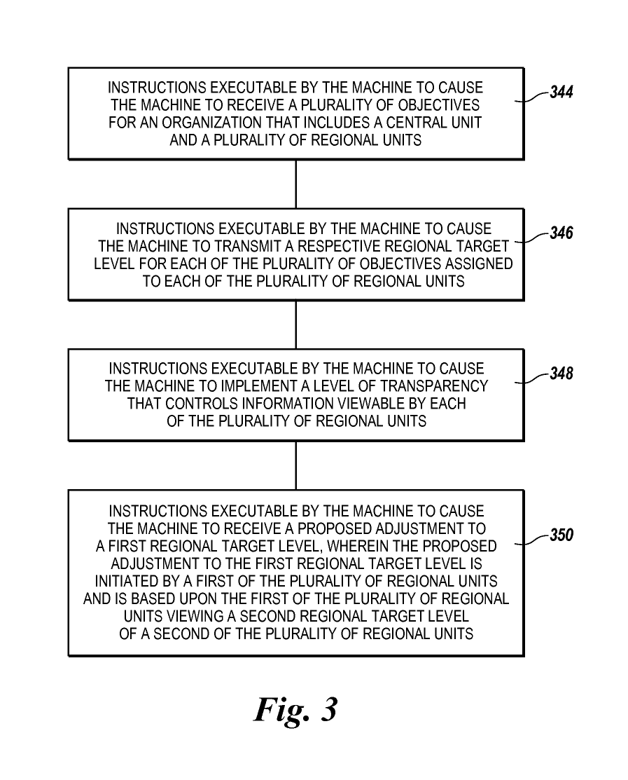

FIG. 3 provides a block diagram illustrating an example of machine readable non-transitory medium storing a set of instructions executable by the machine to cause the machine to perform target level setting according to the present disclosure. The medium can store instructions 344 executable by the machine to cause the machine to receive a plurality of objectives for an organization that includes a central unit and a plurality of regional units. The medium can store instructions 346 executable by the machine to transmit a respective regional target level for each of the plurality of objectives assigned to each of the plurality of regional units. The medium can store instructions 348 executable by the machine to cause the machine to implement a level of transparency that controls information viewable by each of the plurality of regional units. The medium can store instructions 350 executable by the machine to cause the machine to receive a proposed adjustment to a first regional target level, wherein the proposed adjustment to the first regional target level is initiated by a first of the plurality of regional units and is based upon the first of the plurality of regional units viewing a second regional target level of a second of the plurality of regional units. According to some examples of the present disclosure, the medium can store instructions executable by the machine to cause the machine to receive a proposed adjustment to the second regional target level, wherein the proposed adjustment to the second target level is initiated by the second of the plurality of regional units and is based upon the second of the plurality of regional units viewing the first regional target level of the first of the plurality of regional units.

Machine readable and executable instructions and/or logic, which are operable to perform the method described in connection with FIGS. 2 and/or 3, can be present in whole or in part in the examples of other figures. The computing device implemented methods for target level setting, machine readable non-transitory mediums storing a set of instructions executable by the machine, and systems for target level setting as disclosed herein, however, are not limited to the particular examples given herein. Unless explicitly stated, the examples described herein are not constrained to a particular order or sequence. Additionally, some of the described examples, or elements thereof, can occur or be operated at the same, or at least substantially the same, point in time.

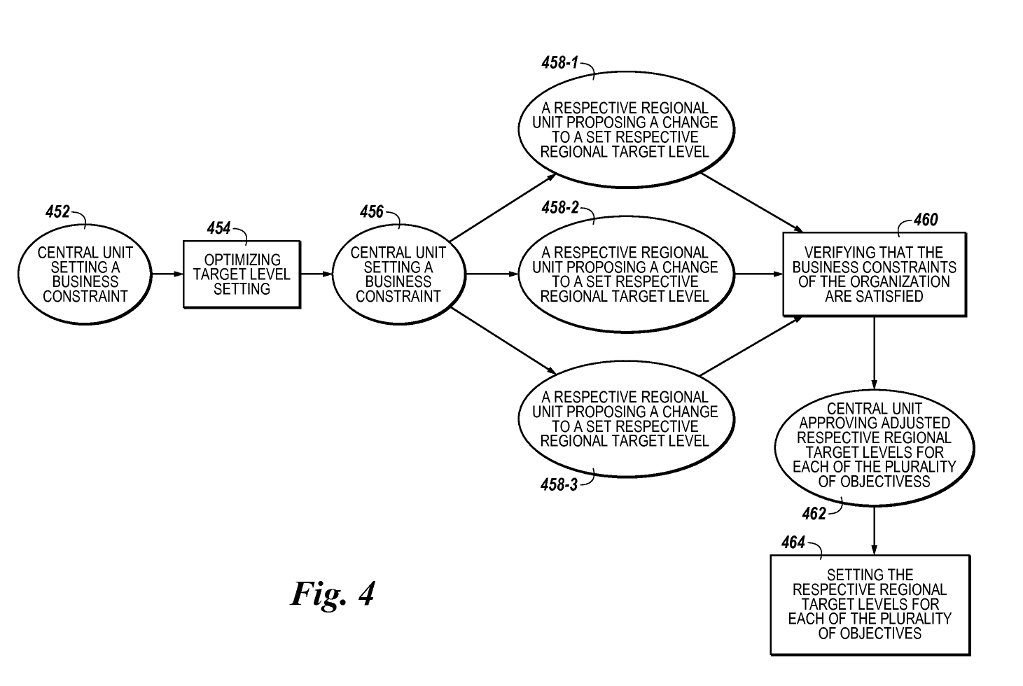

FIG. 4 provides a flow chart illustrating an example of a target level setting according to the present disclosure. Target level setting can include 452 setting a business constraint. As discussed herein, the central unit may provide a plurality of business objectives, e.g. business constraints, for the organization. The business constraints can include, but are not limited to, for example, a minimum regional target level, a maximum regional target level, and/or a business priority, e.g., market share is more important that profits.

Target level setting can include 454 optimizing target level setting. As discussed, target level setting may be utilized to provide that the plurality of objectives of the organization are obtained.

Target level setting can include 456 the central unit setting respective regional target levels for each of the plurality of objectives. The respective regional target levels can be supported by the 454 target level setting optimization. In setting the respective regional target levels, those levels may be distributed to the plurality regional units. According to some examples of the present disclosure and depending upon the level of transparency implemented, a respective regional unit may only view information, e.g. a respective regional target level, that is associated with that regional unit or a respective regional unit may view information, e.g. another respective regional target level, that is associated with another regional unit.

Target level setting can include 458-1, 458-2, 458-3 a respective regional unit proposing a change, e.g. a proposed adjustment to a regional target level, to a set respective regional target level. As discussed, one or more respective regional units may propose an increase and/or propose a decrease to one or more respective regional target levels.

Target level setting can include 460 verifying that the business constraints of the organization are satisfied by the proposed increase and/or proposed decrease to one or more respective regional target levels. For example, if a proposed increase and/or proposed decrease would make one or more of the objectives of the organization unobtainable then the proposed increase and/or proposed decrease may be rejected. However, if the business constraints of the organization are satisfied by the proposed increase and/or proposed decrease then the central unit may again set respective regional target levels for each of the plurality of objectives, where the respective regional target levels incorporate the proposed increase and/or proposed decrease. Based upon the reset respective regional target levels that incorporate the proposed increase and/or proposed decrease one or more of the regional units may again offer a proposed increase and/or proposed decrease to one or more respective regional target levels.

Target level setting can include 462 the central unit approving adjusted respective regional target levels for each of the plurality of objectives. As mentioned above, it may be verified that the business constraints of the organization are satisfied by the proposed increase and/or proposed decrease to one or more respective regional target levels. This verification may utilized by the central unit to approve the respective regional target levels.

Target level setting can include 464 setting the respective regional target levels for each of the plurality of objectives, where the respective regional target levels have been verified to satisfy the business constraints of the organization and have been approved by the central unit.

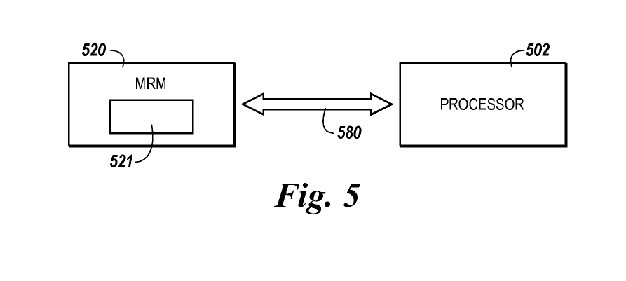

FIG. 5 illustrates a block diagram of an example of a machine readable medium 520 in communication with processor 502 resources according to the present disclosure. The machine readable medium 520 can store computer readable instructions 521 that are executable by the machine to cause the machine to perform a method as described herein. A machine, e.g. a computing device, can include and/or receive a tangible non-transitory machine readable medium (MRM) 520 storing a set of machine readable instructions, e.g. software, for managing settings of a computing device, as described herein. As used herein, processor 502 resources can include one or a plurality of processors such as in a parallel processing system. The machine readable medium 520 can include volatile and/or non-volatile memory such as random access memory (RAM), magnetic memory such as a hard disk, floppy disk, and/or tape memory, a solid state drive (SSD), flash memory, phase change memory, etc.

The MRM 520 can be in communication with the processor 502 resources via a communication path 580. The communication path 580 can be local or remote to a machine associated with the processor 502 resources. Examples of a local communication path 580 can include an electronic bus internal to a machine such as a computer where the MRM 520 is one of volatile, non-volatile, fixed, and/or removable storage medium in communication with the processor 502 resources via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

According to some examples of the present disclosure, the communication path 580 can be such that the MRM 520 is remote from the processor 502 resources such as in the example of a network connection between the MRM 520 and the processor 502 resources, e.g. the communication path 580 can be a network connection. Examples of such a network connection can include a local area network (LAN), a wide area network (WAN), a personal area network (PAN), the Internet, among other examples of networks. In such examples, the MRM 520 may be associated with a first machine, e.g. a server, and the processor 502 resources may be associated with a second machine, e.g. a computing device. The first and second machines can be in communication via a networked communication path 580.

It is to be understood that the above description has been made in an illustrative fashion, and not a restrictive one. Although specific examples have been illustrated and described herein, other component arrangements, instructions, and/or device logic can be substituted for the specific examples shown. Herein, any recitation of steps is neither intended as a requirement that the steps be performed sequentially as recited, nor that one step be completed before another step is begun, unless explicitly so stated. According to some examples of the present disclosure, one or more of the method steps, as discussed herein, may be performed a plurality of times.

What is claimed:

1. A machine readable non-transitory medium storing a set of instructions executable by the machine to cause the machine to:
receive a plurality of objectives for an organization that includes a central unit and a plurality of regional units;
transmit a respective regional target level for each of the plurality of objectives assigned to each of the plurality of regional units;
prompt the central unit for an approval of an increase to a first regional target level for a first of the plurality of regional units and a decrease to a second regional target level for a second of the plurality of regional units;
increase the first regional target level for the first of the plurality of regional units; and
decrease the second regional target level for the second of the plurality of regional units.

2. The medium of claim 1, wherein the first regional target level corresponds to a first objective of the plurality of objectives and the second regional target level corresponds to a second objective of the plurality of objectives.

3. The medium of claim 1, wherein the increase to the first regional target level and the decrease to the second regional target level are initiated by the central unit based upon one or more of the plurality of objectives for the organization.

4. The medium of claim 3, further including implement a level of transparency that controls information viewable by each of the plurality of regional units.

5. The medium of claim 1, wherein the increase to the first regional target level includes receiving a proposed increase to the first regional target level that is initiated by the first of the plurality of regional units.

6. The medium of claim 5, wherein the proposed increase to the first regional target level that is initiated by the first of the plurality of regional units is based upon the first of the plurality of regional units viewing a second regional target level of a second of the plurality of regional units.

7. The medium of claim 1, wherein the decrease to the second regional target level includes receiving a proposed decrease in the second regional target level that is initiated by the second of the plurality of regional units.

8. The medium of claim 7, wherein the proposed decrease that is initiated by the second of the plurality of regional units is based upon the second of the plurality of regional units viewing the first regional target level of the first of the plurality of regional units.

9. A machine readable non-transitory medium storing a set of instructions executable by the machine to cause the machine to:
receive a plurality of objectives for an organization that includes a central unit and a plurality of regional units;
transmit a respective regional target level for each of the plurality of objectives assigned to each of the plurality of regional units;
implement a level of transparency that controls information viewable by each of the plurality of regional units;
receive a proposed adjustment to a first regional target level, wherein the proposed adjustment to the first regional target level is initiated by a first of the plurality of regional units and is based upon the first of the plurality of regional units viewing a second regional target level of a second of the plurality of regional units.

10. The medium of claim 9, wherein implementing the level of transparency includes providing that each of the assigned regional target levels is viewable by each of the plurality of regional units.

11. The medium of claim 9, wherein implementing the level of transparency includes providing that each of the plurality of objectives for the organization is viewable by each of the plurality of regional units.

12. The medium of claim 9, including instructions executable by the machine to cause the machine to receive a proposed adjustment to the second regional target level, wherein the proposed adjustment to the second target level is initiated by the second of the plurality of regional units and is based upon the second of the plurality of regional units viewing the first regional target level of the first of the plurality of regional units.

13. A system for target level setting, comprising:
a processor;
a memory coupled to the processor;
a network connection coupled to the processor;
wherein the processor executes instructions to:
receive via the network connection a plurality of objectives for an organization that includes a central unit and a plurality of regional units;
transmit via the network connection a respective regional target level for each of the plurality of objectives assigned to each of the plurality of regional units;
implement a level of transparency that controls information viewable by each of the plurality of regional units;
receive a proposed adjustment to a first regional target level for a first of the plurality of regional units;
receive a proposed adjustment to a second regional target level for a second of the plurality of regional units;
verify that the proposed adjustment to the first regional target level and the proposed adjustment to the second regional target level satisfy the plurality of objectives for the organization;
implement the proposed adjustment to the first regional target level for the first of the plurality of regional units;
implement the proposed adjustment to the second regional target level for the second of the plurality of regional units; and
prompt the central unit for an approval of the adjusted first regional target level and the adjusted second regional target level.

14. The system of claim 13, wherein the proposed adjustment to the first target level is a proposed increase initiated by the first of the plurality of regional units and is based upon the first of the plurality of regional units viewing the second regional target level of the second of the plurality of regional units.

15. The system of claim 13, wherein the proposed adjustment to the second target level is a proposed decrease initiated by the second of the plurality of regional units and is based upon the second of the plurality of regional units viewing the first regional target level of the first of the plurality of regional units.
